(19) United States
(12) Patent Application Publication
(10) Pub. No.: US 2003/0007423 A1
(43) Pub. Date: Jan. 9, 2003

(54) Method of improving the function of an hour-glass

(76) Inventor: Terry Keith Bryant, Riveria Beach, FL (US)

Correspondence Address: T.K. Bryant, 1281 East Blue Heron Blvd., Riveria Beach, FL, 33404, US

(21) Appl. No.: 09/900,599

(22) Filed: Jul. 9, 2001

(51) Int. Cl. G04F 1/04

(52) U.S. Cl. 368/93

(57) ABSTRACT

The method of dramatically speeding up the time it takes for sand, mercury, or water, or other like substances to flow from the upper compartment to the lower compartment of an hour-glass, usually in an hour, but not specifically required in this method, entails the use of a premolded flexible clear polymer, or any component similar, with the same flexibility properties, molded in the basic shape of an hour-glass, in which one can open the flow canal, which is a small hole located in the center of the hour-glass, through the application of pressure directly to the the above said flexible premolded polymer shape. The process of flexing this premolded form will permit the sand to run between the upper and lower compartments of the hour-glass, allowing the above said components to run through a wider and larger area, from the upper compartment to the lower compartment. Thus, making the hour-glass work more efficiently. When in use the flow canal of the hour-glass will stay in the closed position allowing the flow canal to continue to function for measuring the desired time. By pressing on the sides of the premolded shaped hour-glass, made of the flexible material as described herewithin, one can save the time normally involved in waiting for the sand or other substances to fill the lower compartment, as the flow canal will open, allowing those the sand or other substances to flow freely. Thus, by pressing the sides of the above said flexible premolded form, the size of the original flow canal will substantially increase, allowing the lower compartment to be quickly filled and one can begin using the hour-glass immediately, as the hour-glass will return to its original shape when released. Thus, creating the ability for immediate use when using this new improved hour-glass when measuring time; for games, cooking or other endeavors.

### 1. FIELD OF INVENTION

The present invention relates to the improvement of the already existing invention normally known as the hour-glass, in which a glass vessel is used for the measuring of time in which sand, or other appropriate components or substances run from an upper compartment to a lower compartment and the time for these components to run through the compartments equal the amount of time related to the portion of the component being used. By using clear flexible polymer compartments in the basic shape of an hour-glass, or using a similar or like substance with flexible properties and the utilization of a form which allows sand, or appropriate like material to run from the upper compartment into the lower compartment of the hour-glass more quickly by pressing on the sides of the hour-glass the flow canal, located in the center of the hour-glass, will open allowing the lower compartment to be filled . The flexible form will then immediately return to it's original shape once pressure is released, thus, improving the waiting time between uses and the efficiency of the hour-glass.

### 2. DESCRIPTION OF PRIOR ART

Techniques for measuring time using an hour-glass are accomplished normally using glass molded into the desired shape which allows sand or whatever appropriate substances to travel from the upper compartment to a lower compartment using gravity to pull the sand into the lower compartment through the flow canal which, is a small opening in the center of the hour-glass; between the upper and lower compartments. In order to begin the process of the amount of time it takes the aforementioned substances to travel through the flow canal in the hour-glass, one must wait for the complete transference of the substance in the upper compartment to the lower, as the amount of the material being transferred from the upper compartment to the lower compartment evaluates the exact amount of time the hour-glass is capable of measuring. The above method requires the user to manual turn the hour-glass upside-down to begin the timing process again, which makes the process inoperative for providing an immediate use of the hour-glass as one must always wait for the completion of this transfer from the upper to the lower compartment, and thus, making it time consuming. An advantage of the flexible new design which allows the sand or other substances to be transferred immediately by pressing on the sides of the polymer hour-glass mold and the flow canal, is that on can immediately use the hour-glass without having to wait, as the flexible mold will return to it's shape once pressure is released. Due to the nonflexibility of glass, or even nonflexible plastic this has previously been impossible to due in prior art functions. A disadvantage of prior art was that many times the hour-glass was stored in a game box or in the kitchen, and would easily fall onto it's side, which caused the enclosed material which is normally transferred from the upper compartment of the hour-glass to the lower to settle in both compartments. In order to begin using the prior art again one would have to place the hour-glass back into the up-right position and wait for the process of gravitational pull to transfer the sand, or other substance through the flow canal before one could use the hour-glass to get an accurate time. The solution to this age old problem of how to swiftly use an hour-glass, without having to w wait, has probably been a question in the back of the minds of people throughout history and the complacency was that after over a thousand years of using this apparatus with the same principles applying, we became blinded to the answer. This could be due to the fact that in this modern age of technology the use of polymers and like substances instead of glass, is basicly still a new frontier. The advantage of this new method is that one can use the hour-glass without delay, through the employment of modern technology, to provide a source for measuring time, by simply opening the the flexible flow canal and allowing the sand, or other substances to move immediately between the upper and lower compartments and fill the desired compartment as one chooses, providing a more operable hour-glass.

### SUMMARY OF INVENTION

The present invention provides the user an immediate response to clearing the flow canal located between the upper and lower compartments of an hour-glass, so that the user can begin measuring time at the fastest possible speed, anytime, anywhere, in order that one can, for whatever purpose, use the hour-glass without any delays. This new application will help speed up a game which requires an hour glass, or simply prevent the user from waiting to cook an egg, or for whatever purpose one is using the hour-glass in order to measure time more effeciently. This is accomplished by molding clear flexible polymer, or any substance with like clearness and flexibility, in the shape of the preferred hour-glass, with the ability and resilience to retain the original shape normally sand, or similar material is allowed to run through dramatically increasing the time it takes the sand, or like material to flow from the upper compartment of the hour-glass. Thus, expediting the time the user has to wait, while enhancing the properties of the abilities to measure time using an hour-glass with this new application, providing a time saving step for whatever the purpose; from a game, to cooking, or simply a way to evaluate an amount of time.

A more thorough and comprehensive understanding may be had from the detailed description of the preferred embodiment when read in connection with the drawings.

### BRIEF DESCRIPTION OF THE DRAWINGS

The present invention will be more fully understood by reference to the following detailed description hereof when read in conjunction with the attached drawings, and wherein:

FIG. 1 is a front view a flexible clear premolded polymer, or like substance in the basic shape of and hour-glass (1) showing the covering, though not confined to this exact shape, for keeping the sand contained (2) the areas provided, however not confined to this exact shape, for pressing (3) the flexible mold (1) to release the sand or appropriate substances (5) from the upper compartment (6) into the lower compartment (7) by opening the flow canal (4) in which the sand (5) travels;

FIG. 2 is a side view of FIG. 1 showing the press areas (3) conveniently provided, however, not required for function, of the flexible clear premolded basic shape (1) of the hour-glass;

FIG. 3 is a perspective side view of the process of a person (8) pressing the press areas (3) represented in FIG. 2 and opening the flow canal (4) to allow the sand (5), to flow into the lower compartment (7);

FIG. 4 is a perspective front view of FIG. 3, of a person (8) pressing the press areas (3),represented in FIG. 2 and opening the flow canal (4) to allow the sand (5) to flow into the lower compartment (7);

FIG. 5 is a prospective front view of a person (8) releasing the press areas (3) represented in FIG. 2 of the flexible clear premolded polymer shape represented in FIG. 1, and allowing the flow canal (4) to renew it's original shape after the sand (5) has filled the lower compartment (7).

### DETAILED DESCRIPTION OF THE PREFERRED EMBODIMENT

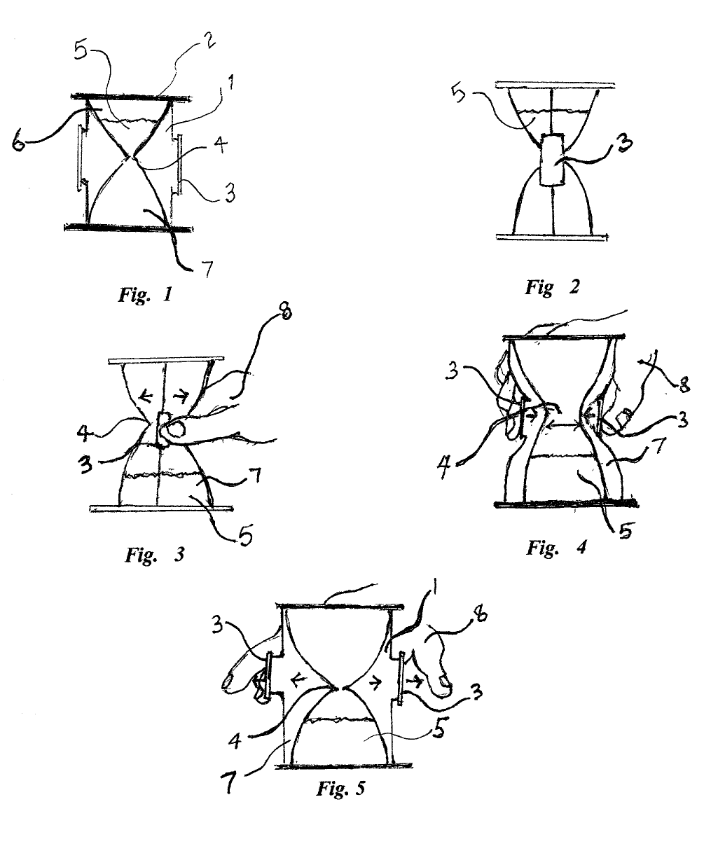

The present invention is the method of transferring sand (5) or other appropriate materials used in hour-glass (1) employs molding clear flexible polymer or like substance into an hour-glass basic shape (1) FIG. 1 in which by putting pressure on the sides (3) FIGS. 3-4 allow the sand (5) in the upper compartment (6) FIG. 1 to run into the lower compartment (7) FIG. 5 this opens the flow canal (4) FIGS. 3-4 due to the flexibility of the molded flexible polymer shape (1) FIG. 1 by releasing the pressure on the sides (3) FIG. 5 the clear flexible hour-glass will return to it's original shape FIG. 5 having thus described in detail the preferred apparatus which embodies the concepts and principles of the invention and which accomplishes the various objects, purposes and aims thereof, it is to be appreciated and will be apparent to those skilled in the art.

What I claim as my invention is:

1. A method of dramatically improving the speed in which hour-glass works comprising of the step of:
providing a clear flexible polymer or similar material pre-formed in the shape of an hour-glass which can dramatically increase the time in which the sand or like material can run through the flow canal of the hour-glass in order to fill the desired compartment and allow the user to begin using the hour-glass without having to wait;
applying pressure on the sides of the flexible shape and thus opening the flow canal allowing the sand or like material to pass freely and fill the desired compartment of the hour-glass;
releasing the pressure on the sides of the flexible shape and thus allowing the flow canal and the hour-glass to return to it's original shape.

2. The method of claim 1 further comprising of pressing on the sides to allow the sand or similar material appropriate for use to run quickly run through the upper compartment of the hour-glass into the lower compartment of the hour-glass.

3. The method of claim 2 comprising of forming an basic or similar shape of an hour-glass comprising of using a flexible clear polymer or substance or similar likeness that has flexibility properties which will allow the basic shape of the hour-glass to flex when pressure is applied to the of appropriate areas; thus allowing the flow canal located between the upper and lower compartments in which the sand or similar material runs through to open thus well allowing the immediate ability to fill the desired compartment of the hour-glass with the sand or like material; directly interposing said flexible areas when being pressed will open the flow canal increasing the amount of sand or any appropriate material that can be used in an hour-glass to run freely between the two chambers or compartments of the hour-glass itself.

4. The method of claim 3 further comprising of the flexibility of the hour-glass shape when released to return to it's original form allowing an immediate use of the hour-glass without delay.
